(19) United States
(12) Patent Application Publication
(10) Pub. No.: US 2008/0046099 A1
(43) Pub. Date: Feb. 21, 2008

(54) Method and system for customizing access to content aggregated from multiple sources

(76) Inventors: Brian Belmont, West Linn, OR (US); Lincoln Wilde, Portland, OR (US); Randy Dunton, Phoenix, AZ (US)

Correspondence Address: INTEL CORPORATION;c/o INTELLEVATE, LLC, P.O. BOX 52050, MINNEAPOLIS, MN, 55402, US

(21) Appl. No.: 11/506,458

(22) Filed: Aug. 18, 2006

(51) Int. Cl. G05B 11/01

(52) U.S. Cl. 700/11

(57) ABSTRACT

A method and system for customizing access to content aggregated from multiple sources. A method includes selecting at least two content items, where the at least two content items are the result of a search from at least two sources, saving the at least two content items in a container, determining a channel, mapping the container to the channel and allowing access to the at least two content items in the container via the channel.

### BACKGROUND

The importance for the consumer electronic device industry to continuously strive to produce products that are easy to use cannot be overstated. No doubt this is one of the reasons for the introduction of the electronic program guide (EPG), the home entertainment center and the remote control, to name a few. For example, today's homes may have one or more electronic devices, such as personal computers (PCs), televisions, digital video disk (DVD) players, video cassette recorder (VCR) players, compact disk (CD) players, set-top boxes, stereo receivers, audio/video receivers (AVRs), media centers, personal video recorders (PVRs), gaming devices, digital camcorders, digital cameras, and so forth, all connected together in such a way to provide a user with a means for entertainment via the home entertainment center and a single display device.

As the number of devices in the entertainment center continues to grow, so does the complexity and frustration for the user to be able to interface with all of the devices in the entertainment center to access available content. It is therefore desirable to have an intuitive user interface that provides a high degree of user friendliness for people who lack computer experience and/or have many electronic consumer devices connected to a home entertainment center. One example of an intuitive user interface that a large percentage of people are familiar with is the television user interface and the EPG.

### BRIEF DESCRIPTION OF THE DRAWINGS

The invention may be best understood by referring to the following description and accompanying drawings that are used to illustrate embodiments of the invention. In the drawings:

FIG. 1 illustrates an example of a television user interface and channel guide that may be utilized by the invention;

FIG. 2 illustrates an embodiment of an environment for the invention, in which some embodiments may operate;

FIG. 3 illustrates an embodiment of an environment for the invention, in which some embodiments may operate;

FIG. 4 illustrates an embodiment of the command interpreter of the invention;

FIG. 5 illustrates an embodiment of the dispatcher of the invention;

FIG. 6 illustrates an embodiment of the mapper of the invention;

FIG. 7 illustrates an embodiment of an environment for the invention, in which some embodiments may operate; and

FIG. 8 is a flow diagram of one embodiment of a process for customizing access to content aggregated from multiple sources, in which some embodiments of the invention may operate.

### DESCRIPTION OF EMBODIMENTS

According to an embodiment of the invention, a method and system for customizing access to content aggregated from multiple sources are described. A television user interface (such as a remote control) and channel guide may be used by a viewer to provide commands in order to search for available networked content, aggregate one or more items into a container, assign or map a channel to the container, display the channel guide, select a channel, select and display an item in a container associated with the channel, and so forth. In some embodiments of the invention, a virtualized platform is partitioned and is applied to a digital television domain. Each channel may represent an analog broadcast channel; a digital broadcast channel; data pre-recorded and stored on a digital recording device; data available for streaming, downloading or accessing via the Internet (e.g., Web site or RSS feed); movies or other media stored on a home local area network (LAN); and so forth.

In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

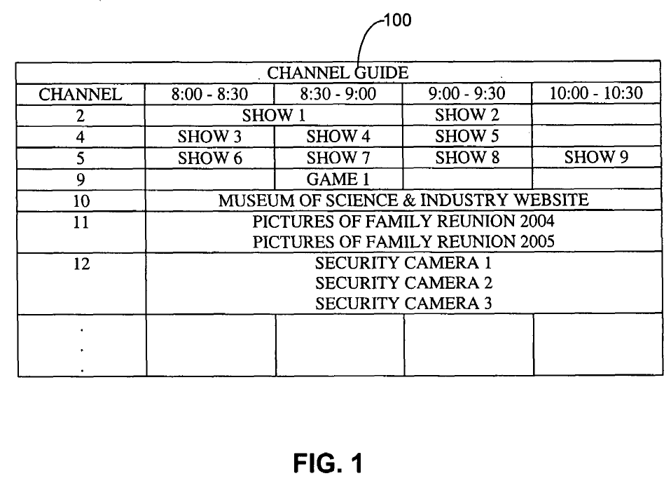

FIG. 1 illustrates an example television user interface and channel guide 100 that may be utilized by the invention. Referring to FIG. 1, analog broadcast channels, digital broadcast channels, content pre-recorded and stored on a digital recording device, content available for streaming or downloading via the Internet, content stored on a home LAN, and so forth, may be merged, displayed and available via the channel guide. Specific types of content may include, but are not limited to, analog and digital broadcasted shows or programs, Web sites, photographs stored locally, live monitoring via a security camera, on-line games, stored games, stored programs, stored video, audio podcasts and so forth.

Referring to FIG. 1, channels 2, 4 and 5 display standard broadcast shows. Channel 9 displays that between 8:30 and 9:00, an on-line game of “GAME I” is taking place via a Web site. Channel 10 displays a listing for “Museum of Science & Industry,” corresponding to the www.museum.com Web site. According to an embodiment of the invention, just as a user would select channel 4 at 8:00 p.m. in order to view “SHOW 3,” the user may select channel 10 at any time in order to be presented with the Museum of Science & Industry exhibits.

Channels 11 and 12 may also be accessed in a similar manner as described above, although the invention allows for a viewer to toggle through multiple selections for each channel. For example, the viewer may use a remote control device or any other interface device to issue Next and Previous Commands to toggle through the multiple selections. In an embodiment of the invention, if no selection is made by the viewer then the default may be to display the first selection. For example, channel 11 displays two digital data files stored on a local drive, pictures of a family reunion 2004 and pictures of a family union 2005. The viewer may select which digital data file to view on channel 11. If no selection is made, then pictures of a family reunion 2004 may automatically be displayed. In another example, channel 12 is capable of displaying live footage of three different security cameras positioned to monitor the family's home. Again, the user may select which live footage to view on channel 12. The channel guide of FIG. 1 may be utilized by a viewer to select what content to watch, listen to, play, record, download, etc. The example television user interface and channel guide 100 of FIG. 1 is provided for illustration purposes only and is not meant to limit the invention. For example, information in channel guide 100 could be textual or graphical (i.e. images). For instance, instead of the text of ‘Security Camera 1, 2, 3”, channel guide 100 could display thumbnail images of the three cameras. Likewise, visual images could be used for the various TV shows, and so forth.

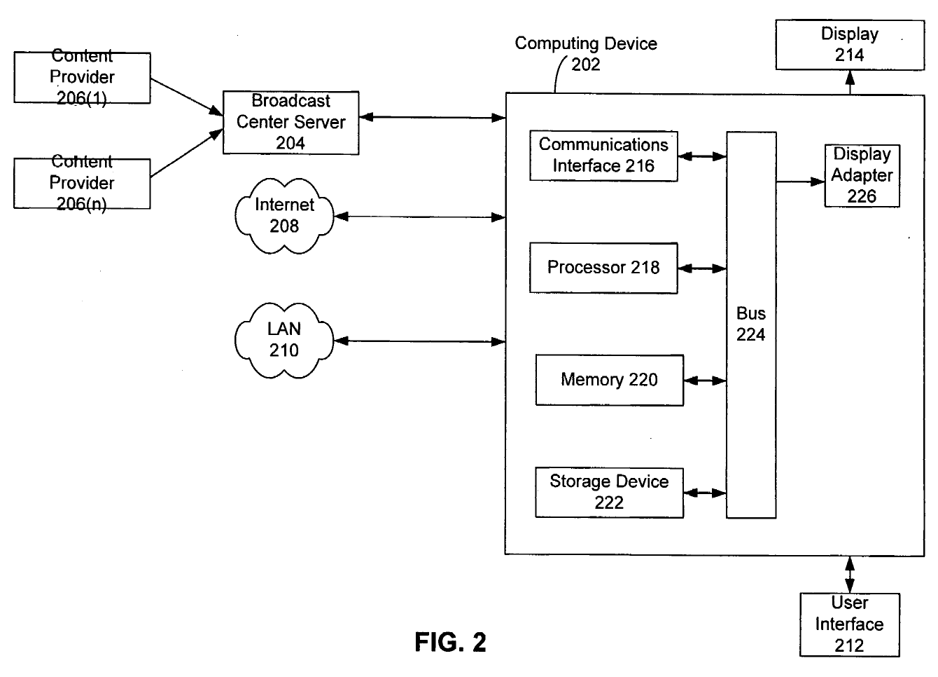

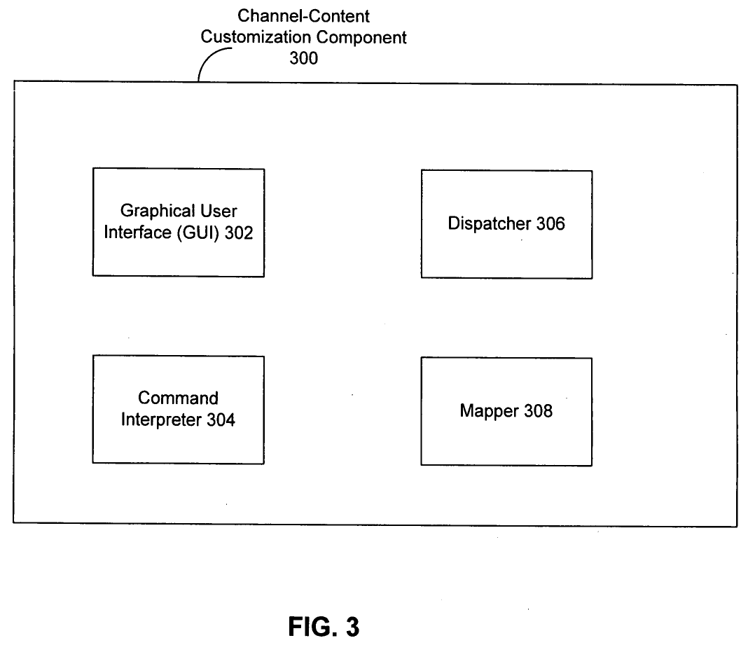

FIGS. 2 and 3 each illustrate an embodiment of an environment for the invention, in which some embodiments may operate. The specific components shown in FIGS. 2 and 3 represent one example of a configuration that may be suitable for the invention and is not meant to limit the invention. Thus, other embodiments of the invention may include more or less components as described in each of FIGS. 2 and 3. For example, the functionality of two or more components of FIGS. 2 and 3 may be combined into one component. Likewise, the functionality of one component of FIG. 2 or 3 may be separated and performed by more than one component. Each component shown in FIG. 2 or 3 may be implemented as a hardware element, as a software element executed by a processor, as a silicon chip encoded to perform its functionality described herein, or any combination thereof.

The environments of each of FIGS. 2 and 3 may be implemented as a wired communication system, a wireless communication system, or a combination of both. Although the environment of each of FIGS. 2 and 3 may be illustrated using a particular communication medium by way of example, it may be appreciated that the principles and techniques discussed herein may be implemented using any type of communication media and accompanying technology. The embodiments are not limited in this context. Other communication systems may be added or substituted according to the particular application for the environment in FIGS. 2 and 3 and/or as new types of systems are developed.

Referring to FIG. 2, the environment may include, but is not necessarily limited to, a computing device 202, a broadcast center server 204, one or more content providers 206(1)-206(n), the Internet 208, a local area network (LAN) 210, a user interface 212 and a display 214. Computing device 202 may include, but is not necessarily limited to, a communications interface 216, a processor 218, memory 220, a storage device 222, a bus 224 and a display adapter 226. At a high level and in an embodiment of the invention, computing device 202 may receive content and related guide data for a channel guide (such as the one described in FIG. 1) from broadcast center server 204, the Internet 208, LAN 210 and from content stored on computing device 202 itself. Computing device 202 may also receive input via user interface 212. The channel guide may be displayed on display 214.

In an embodiment of the invention, content may include, but is not necessarily limited to, shows or programs, voice, audio, music, graphics, video games, books, and so forth. In an embodiment of the invention, related guide data may include, but is not necessarily limited to, content name, channel or location (e.g., location on the Internet 208 via an Internet Protocol (IP) address or Uniform Resource Location (URL), location on a hard disk found in LAN 210, location on computing device 202 itself, etc.), type of content (e.g., broadcast, streaming video, media download, etc.), metadata (e.g., content description, year of release, ratings information, category, etc.), air time, a brief synopsis, actors, directors, and so forth. These examples are not meant to limit the invention. Each of the components of FIG. 2 is described next in more detail.

Computing device 202 may be any device adapted to include the functionality of the present invention. For example, device 202 may be a digital television, set-top box, a digital video recorder, a digital network recorder, a personal computer, a portable computer, a cellular telephone, a personal digital assistant (PDA), a computing tablet, or any other similar device. Although only one computing device 202 is depicted in FIG. 2, the invention may involve multiple computing devices 202.

In an embodiment of the invention, computing device 202 may include communications interface 216 that allows for the receipt of high-speed digital data such as a cable modem, DSL modem, Ethernet interface, satellite receiver, etc. Computing device 202 may also include a non-volatile storage device 222 for storing received digital data for later access. Such storage devices typically include magnetic media such as hard disk drives and may include other machine readable media such as optical disks, card and stick memory devices, flash memory devices, and the like. Storage device 222 may be a local storage device (e.g., external harddrive, networked HDD, or a USB thumb drive).

In one embodiment, the invention is included in computing device 202 as software that is stored on storage device 222 or other machine readable medium and is executed by processor 218 which utilizes memory 220. Processor 218 may be any processor, and memory 220 may be any kind of random access memory (RAM) or other form of memory.

Computing device 202 may process received content and related guide data to create a channel guide and sends a resulting signal via display adapter 226 to display 214 to be presented to a viewer. Communications interface 216, processor 218, memory 220, storage device 222 and display adapter 226 are, in one embodiment, coupled to bus 224. In various embodiments, computing device 202 may include multiple communications interfaces, processors, storage devices, display adapters and buses, as well as other components not shown in FIG. 2. In various embodiments, computing device 202 may include an audio processor and/or game processor or game interface, one or more digital tuners, one or more analog tuners, and so forth.

In an embodiment of the invention, computing device 202 may receive content and related guide data for a channel guide from broadcast center server 204, the Internet 208 and LAN 210. This may be a straight download of all content and related guide data or may be a query to limit the amount of information received by computing device 202. Content and related guide data used for the channel guide may also be recorded on computing device 202 itself (e.g., in storage device 222). Broadcast center server 204 may receive data from at least one content provider 206 and forwards digital data to computing device 202. Content providers 206 may be a server computer or a group, subnetwork, LAN or other group of multiple computers, that provide data to broadcast center server 204.

The Internet 208 may be used by computing device 202 for streamed content and related guide data (such as via subscription services) and for downloadable content and related guide data (such as video/audio from an Internet-based store that allows a user to purchase video/audio). LAN 210 may be a household, office, and be connected to a media server, a network storage device or personal computers that contain content, such as, for example, recorded television programs, photographs and audio files.

In embodiments of the invention, connections between content providers 206, broadcast center server 204, the Internet 208, LAN 210 and computing device 202 may be one or more of T1 lines, T3 lines, coaxial cable, Ethernet, twisted-pair, fiber optics such as a Synchronous Optical Network (SONET), digital television (DTV), cable television (CATV), microwave, satellite, radio waves, or any combination of wired/wireless communications.

In an embodiment of the invention, broadcast center server 204, the Internet 208 and LAN 210 may receive content as digital data or analog data. If analog data is received, it may be converted into an appropriate digital format before being forwarded to computing device 202. When content is received as analog data, it may be any well-known or proprietary analog format, such as the National Television System Committee (NTSC) format.

The format of the content sent to computer device 202 may be any digital data format, including, for example, data interchange formats such as Internet Protocol (IP) Packets and File Transfer Protocol (FTP) packets; combined audio and moving video formats such as the formats promulgated by the International Telecommunications Union (ITU), the Advanced Television Systems Committee (ATSC), and similar organizations such as High Definition Television (HDTV) and Moving Pictures Expert Group (MPEG); related audio formats; still video formats such as Joint Photographic Experts Group (JPEG) format, Graphic Interchange Format (GIF); and so forth.

In an embodiment of the invention, the channel guide may be displayed on display 214. Display 214 may be external to computing device 202 or may be incorporated into device 202. Display 214 may be a cathode ray tube (CRT) display monitor, a thin film transistor (TFT) display screen, a liquid crystal display (LCD), or any display device suitable for displaying graphics and images.

User interface 212 may be any device capable of allowing one or more viewers to interface with computing device 202 and/or manipulate the channel guide (e.g, an input device). User interface 212 may be external to computing device 202 or may be incorporated into device 202. For example, user interface 212 may be utilized by one or more viewers to log into computing device 202, to provide commands in order to search for content items, to aggregate one or more content items into a container, to assign/map a channel to the container, to display a channel guide, to select a channel, to select and display a content item in a container associated with the channel, and so forth. In embodiments of the invention, user interface 212 may be implemented as a remote control, a PDA, a touch screen or button(s) on the display 214 or computing device 202, a joystick, a keyboard, a game pad, a personal computer, a laptop computer, a cellular phone, and so forth, or any combination of these. These examples are provided for illustration purposes only and are not meant to limit the invention.

The environment of FIG. 2 may be adapted to include the functionality that will now be described with reference to FIG. 3. FIG. 3 illustrates one embodiment of a channel-content customization component 300. In an embodiment of the invention, component 300 may facilitate one or more viewers to customize access to content items aggregated from multiple sources. Here, a viewer may search for content that is available via multiple sources. The viewers may customize a channel guide (such as channel guide 100 of FIG. 1) by aggregating or combining one or more content items into a container and assigning/mapping the container to a specific channel number. The viewer may then access the content items in the container by selecting the assigned channel via the channel guide, via “Next” and “Previous” commands, via entering the channel number directly, and so forth.

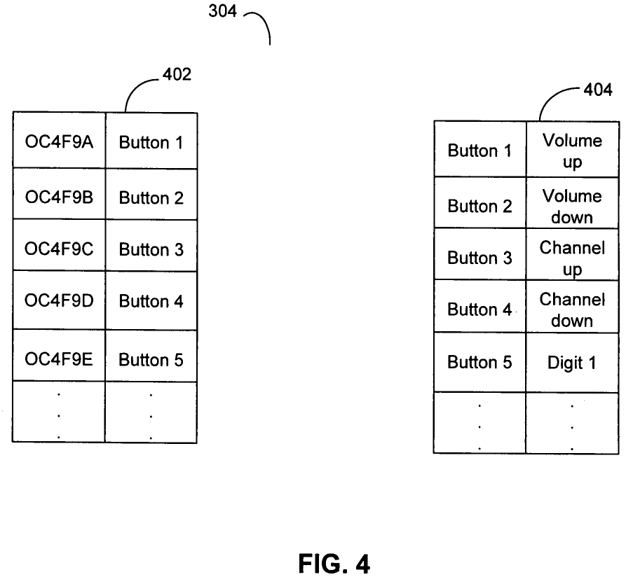

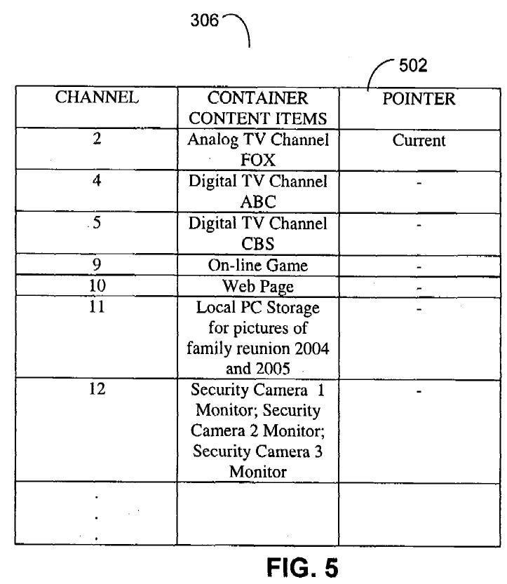

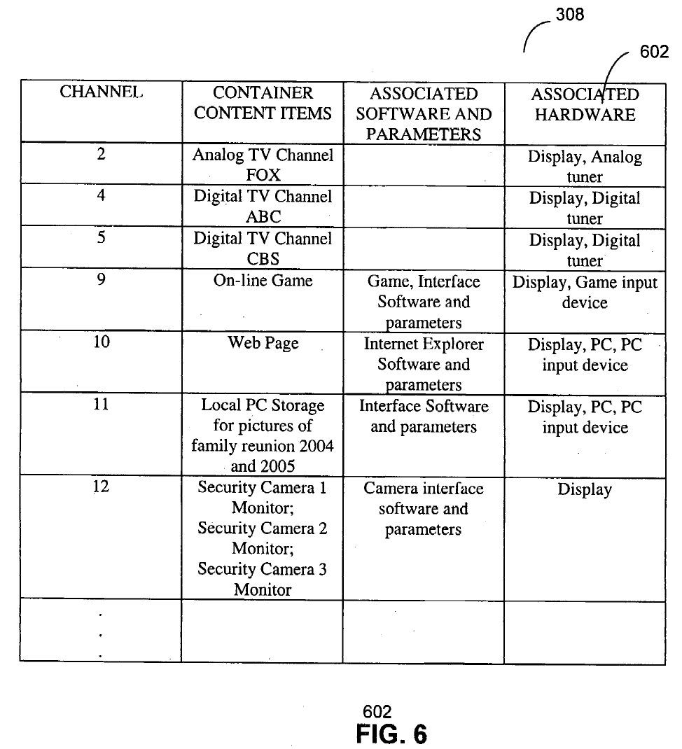

As illustrated in FIG. 3, channel-content component 300 may include, but is not necessarily limited to, a graphical user interface (GUI) 302, a command interpreter 304, a dispatcher 306 and a mapper 308. In an embodiment of the invention, GUI 302 may be incorporated into a television remote control (such as user interface 212 of FIG. 2) or displayed on a television screen (such as display 214 of FIG. 2) and may be used to provide commands in order to search for content items, aggregate one or more content items into a container, assign a channel to the container, display a channel guide, select a channel, select and display a content item in a container associated with the channel, and so forth. Command interpreter 304, dispatcher 306 and mapper 308 process the commands received from the television remote control and the output of the processing is displayed on a display (such as display 214 of FIG. 2). An embodiment of command interpreter 304 is described below with reference to FIG. 4. An embodiment of dispatcher 306 is described below with reference to FIG. 5. An embodiment of mapper 308 is described below with reference to FIG. 6.

FIG. 4 illustrates an embodiment of command interpreter 304 of the invention. Here, command interpreter 304 maintains two tables 402 and 404. Table 402 performs the function of converting the bits that are received from a remote control into a corresponding button on the remote control. For example, as illustrated, the bits “0C4F9A” correspond to button 1 on the remote control. Unfortunately, however, button 1 does not have a meaning to command interpreter 304 until it can determine the functionality of button 1. Table 404 maintains information that allows command interpreter 304 to translate the buttons into their corresponding functionality. For example, as illustrated, button 1 corresponds to a “volume up” button. Command interpreter 304 thus knows that if it receives bits 0C4F9A from the remote control, the user has just pressed the “volume up” button on the remote control. It will be apparent to one of ordinary skill in the art that command interpreter 304 may also be implemented in other ways that achieve the same result as described above.

FIG. 5 illustrates an embodiment of dispatcher 306 of the invention. Dispatcher 306 maintains a table 502 that includes information about the type of content item or activity that is available on each of the channels displayed in the channel guide. Dispatcher 306 also includes a pointer that informs the processing unit of the current channel being viewed by the viewer. As illustrated in table 502, the current channel is channel 2. If the viewer selects channel 10, for example, the pointer will move to channel 10, thus telling the processing unit that channel 10 is displaying a Web page. In this situation, the processing unit knows that it has to establish a connection to the Web in order for the viewer to view the Web page selected on channel 10. Where a container includes multiple content items, a secondary pointer may be implemented to inform the processing unit of the selected content item that is being viewed by the viewer. If a viewer creates a container and assigns the container to a new channel, the new channel and its associated information (e.g., content items) are added to table 502. It will be apparent to one of ordinary skill in the art that dispatcher 306 may also be implemented in other ways that achieve the same result as described above.

FIG. 6 illustrates an embodiment of mapper 308 of the invention. Mapper 308 maintains a table 602. For each channel, table 602 maintains information regarding which content item(s) are assigned to the container for the particular channel and whether any software and parameters and/or hardware is associated with the content item(s). For example, channel 2 has one content item in its mapped container, which is the analog TV channel FOX. The analog TV channel FOX has associated hardware that includes a display and an analog tuner. Channel 4 has one content item in its mapped container, which is the digital TV channel ABC. Digital TV channel ABC has associated hardware that includes a display and a digital tuner. Channel 11 has two content items in its container, local PC storage for pictures of family reunion 2004 and local PC storage for pictures of family reunion 2005. Each of these items has associate interface software and parameters and associated hardware that includes a display, a PC and a PC input device. If a viewer creates a container and assigns the container to a new channel, the new channel and its associated information (content items, software and parameters and/or hardware) are added to table 602. It will be apparent to one of ordinary skill in the art that table 602 may also be implemented in other ways that achieve the same result as described above.

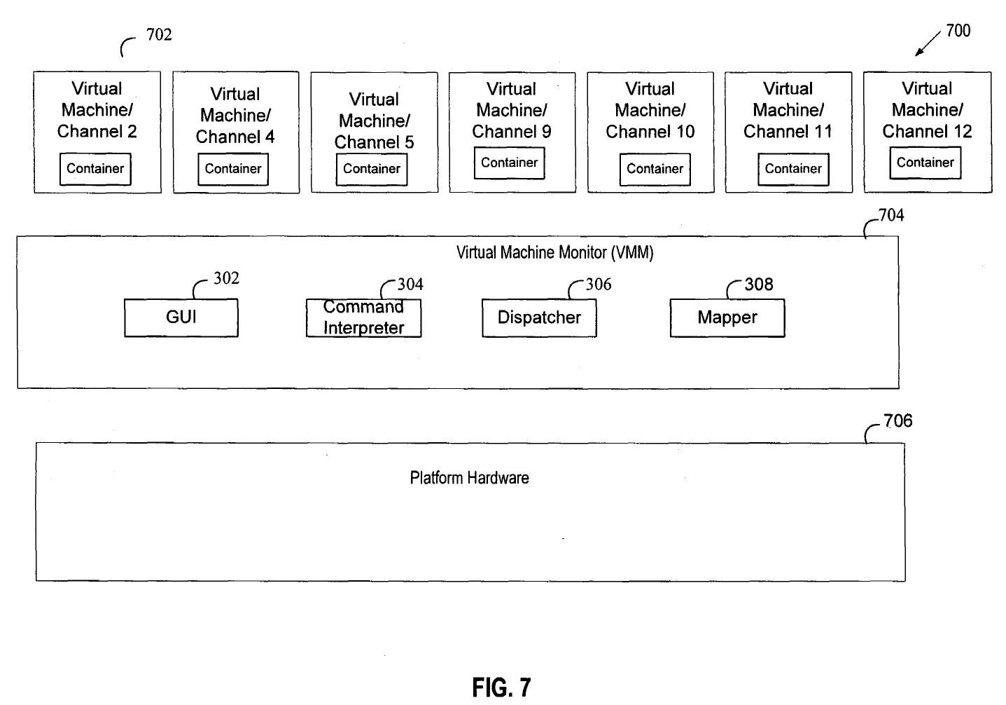

FIG. 7 illustrates an embodiment of an environment for the invention, in which some embodiments may operate. In FIG. 7, the invention is implemented via an embodiment of a virtualized platform. Other embodiments of the invention may be implemented via a computer with a multitasking operating system. In general, a virtualized platform is a single physical platform that is segregated into a plurality of virtual networks. The physical platform incorporates at least one virtual machine monitor (VMM). A conventional VMM typically runs on a computer and presents to other software the abstraction of one or more virtual machines. Each virtual machine may function as a self-contained platform, running its own “guest operating system” (i.e., an operating system (OS) hosted by the VMM) and other software, collectively referred to as guest software.

Processes running within a virtual machine are provided with an abstraction of some hardware resources and may be unaware of other virtual machines within the system. A hypervisor provides the virtualization abstraction of computer systems underneath it. Every virtual machine assumes that it has full control over the hardware resources allocated to it. The VMM is an entity that is responsible for appropriately managing and arbitrating system resources among the virtual machines including, but not limited to, processors, input/out (I/O) devices and memory.

In the embodiment described herein in relation to FIG. 7, a virtualized platform is partitioned and is applied to a digital television domain. Each television channel is assigned to and managed by its virtual machine. Each channel may represent an analog broadcast channel; a digital broadcast channel; data pre-recorded and stored on a digital recording device; data available for streaming, downloading or accessing via the Internet (e.g., Web site); data stored on a home local area network (LAN); and so forth. A television user interface and channel guide (such as the one illustrated in FIG. 1) may be used by a viewer to activate a virtual machine based on a channel selection.

Referring to FIG. 7, the environment includes, but is not necessarily limited to, one or more virtual machines 702, a VMM 704 and platform hardware 706. Though seven virtual machines are shown in FIG. 7, it is understood that any number of virtual machines may be present in environment 700. Each of these components is described next in more detail.

One television channel is assigned to each of the virtual machines 702. Each virtual machine 702 includes a container where the container may include one or more content items. Each virtual machine 702 may also include an operating system hosted by the particular virtual machine and one or more software applications that are needed to support the particular channel and/or container items assigned to the virtual machine.

VMM 704 may include, but is not limited to, a hypervisor (not shown in FIG. 7), GUI 302, command interpreter 304, dispatcher 306 and mapper 308 (as illustrated above with reference to FIG. 3). In an embodiment of the invention, a television remote control (such as user interface 212 of FIG. 2) may be used to provide commands in order to search for content items, aggregate one or more content items into a container, assign a channel to the container, display a channel guide, select a channel, select and display a content item in a container associated with the channel, and so forth. Command interpreter 304, dispatcher 306 and mapper 308 process the commands received from the television remote control and the output of the processing is displayed on a display (such as display 214 of FIG. 2).

Platform hardware 706 can be of a personal computer (PC), digital television, mainframe, handheld device, portable computer, set-top box, or any other computing system, that is adapted to perform the functionality of the invention. In an embodiment of the invention platform hardware 706 is similar to the computing device 202 described above with reference to FIG. 2.

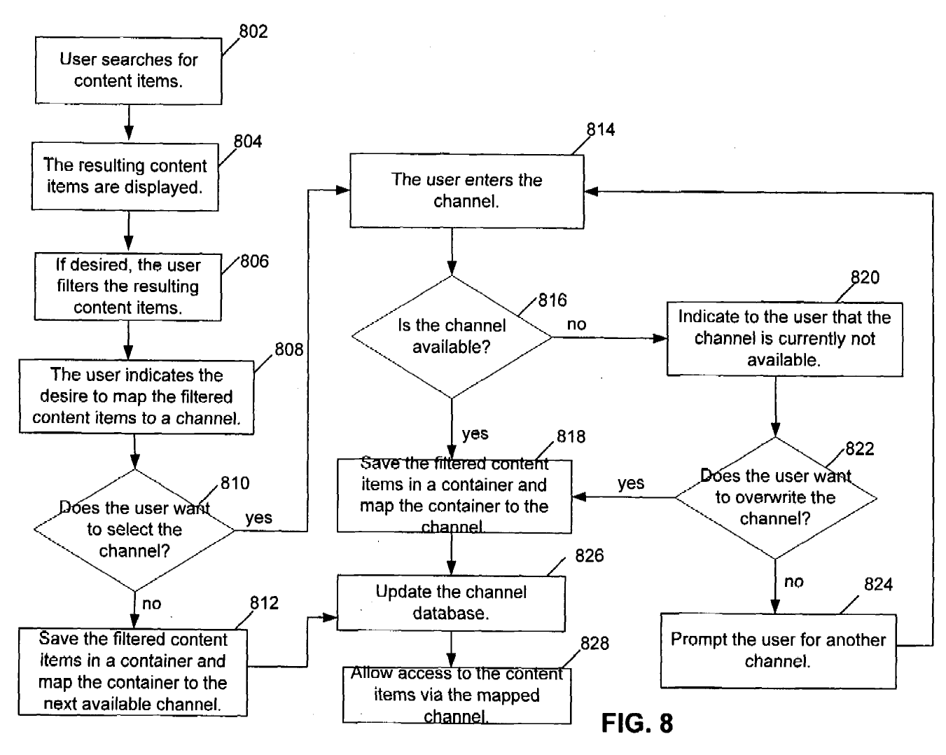

Embodiments of the operation of the present invention are described next with reference to FIG. 8. The flow diagram and other descriptions of processes herein are not intended to imply a fixed order of performing the process stages. Rather, the process stages may be performed in any order that is practicable.

FIG. 8 is a flow diagram of one embodiment of a process for customizing access to content aggregated from multiple sources, in which some embodiments of the invention may operate. Referring to FIG. 8, the user searches for content items (block 802). Here, the user may utilize a user interface (such as user interface 212 of FIG. 2) to enter keywords or commands to search for content items from multiple sources. A computing device (such as computing device 202 of FIG. 2) may utilize the keywords or commands to search for content such as analog broadcast content, digital broadcast content, content pre-recorded and stored on a digital recording device, content available for streaming or downloading via the Internet, content stored on a home LAN, and so forth. The resulting content items are displayed to the user (block 804).

If desired, the user may filter the resulting content items to include only those of which he or she is most interested (block 806). The user indicates the desire to map the filtered content items to a channel (block 808). If the user does not want to select a channel (block 810), then the next available channel is determined and the filtered content items are saved in a container. The container is then mapped to the appropriate channel (block 812). In an embodiment of the invention, 1-touch channel mapping allows the user to map the container with the content items to the next available channel.

The channel database is then updated (block 826). In an embodiment of the invention, table 502 of FIG. 5 and table 602 of FIG. 6 are updated accordingly. Alternatively, if the user wants to select a channel in block 810, then the user enters the channel (block 814).

It is then determined whether the selected channel is available (block 816). If so, then the filtered content items are saved in a container and mapped to the selected channel (block 818). The channel database is then updated (block 826). In an embodiment of the invention, table 502 of FIG. 5 and table 602 of FIG. 6 are updated accordingly. The user may access the content items in the container via the mapped channel (block 828).

If the selected channel is not available in block 816, then it is indicated to the user that the selected channel is currently not available (block 820). If the user wants to overwrite the selected channel (block 822), then control returns to block 818 as described above. Alternatively, the user is prompted for another channel (block 824). Control then returns to block 814 to allow the user to enter another channel.

The above concept may further be extended to a network-based family channel or other affinity group, where members may post photographs, video or music content, etc., to a networked server. A channel may then be mapped to a playlist of content items that all members of the family or group can “tune to” in order to access the content items.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc-Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
selecting at least two content items, wherein the at least two content items are the result of a search from at least two sources;
saving the at least two content items in a container;
determining a channel;
mapping the container to the channel; and
allowing access to the at least two content items in the container via the channel.

2. The method of claim 1, wherein allowing access to the at least two content items in the container via the channel is accomplished via channel input controls and a channel guide.

3. The method of claim 1, wherein determining the channel comprises determining the next available channel.

4. The method of claim 1, wherein determining the channel comprises allowing a user to select an available channel.

5. The method of claim 1, wherein each of the at least two content items may comprise one of an analog broadcast channel, a digital broadcast channel, data pre-recorded and stored on a digital recording device, data available for streaming via the Internet, data available for downloading via the Internet, data available via a Web site, and data stored on a separate device connected with a local area network (LAN).

6. The method of claim 1, wherein the at least two sources are networked together.

7. A system comprising:
a platform having virtual machines, wherein each of one or more television channels is associated with one of the virtual machines;
a mapper for allowing a user to map at least two content items to a television channel of the one or more television channels; and
a channel guide to allow access to the at least two content items in the container via the mapped television channel.

8. The system of claim 7, wherein the at least two content items are saved in a container that is associated with the mapped television channel.

9. The system of claim 7, wherein the mapped television channel is determined by the next available television channel.

10. The system of claim 7, wherein the mapped television channel is determined by a user.

11. The system of claim 7, wherein the at least two content items are the result of a search from at least two networked sources.

12. The system of claim 7, wherein each of the at least two content items may comprise one of an analog broadcast channel, a digital broadcast channel, data pre-recorded and stored on a digital recording device, data available for streaming via the Internet, data available for downloading via the Internet, data available via a Web site, and data stored on a separate device connected with a local area network (LAN).

13. A system comprising:
a mapper for allowing a user to map at least two content items to a television channel; and
a channel guide to allow access to the at least two content items via the mapped television channel.

14. The system of claim 13, wherein the at least two content items are saved in a container that is associated with the mapped television channel.

15. The system of claim 13, wherein the mapped television channel is determined by the next available television channel.

16. The system of claim 13, wherein the mapped television channel is determined by a user.

17. The system of claim 13, wherein the at least two content items are the result of a search from at least two networked sources.

18. The system of claim 13, wherein each of the at least two content items may comprise one of an analog broadcast channel, a digital broadcast channel, data pre-recorded and stored on a digital recording device, data available for streaming via the Internet, data available for downloading via the Internet, data available via a Web site, and data stored on a separate device connected with a local area network (LAN).

19. A machine-readable medium containing instructions which, when executed by a processing system, cause the processing system to perform a method, the method comprising:
selecting at least two content items, wherein the at least two content items are the result of a search from at least two sources;
saving the at least two content items in a container;
determining a channel;
mapping the container to the channel; and
allowing access to the at least two content items in the container via the channel.

20. The machine-readable medium of claim 19, wherein allowing access to the at least two content items in the container via the channel is accomplished via channel input controls and a channel guide.

21. The machine-readable medium of claim 19, wherein determining the channel comprises determining the next available channel.

22. The machine-readable medium of claim 19, wherein determining the channel comprises allowing a user to select an available channel.

23. The machine-readable medium of claim 19, wherein each of the at least two content items may comprise one of an analog broadcast channel, a digital broadcast channel, data pre-recorded and stored on a digital recording device, data available for streaming via the Internet, data available for downloading via the Internet, data available via a Web site, and data stored on a separate device connected with a local area network (LAN).
